(19) United States
(12) Patent Application Publication
(10) Pub. No.: US 2008/0174932 A1
(43) Pub. Date: Jul. 24, 2008

(54) CAPACITOR ASSEMBLY, DISPLAY DEVICE HAVING THE SAME, AND METHOD OF MANUFACTURING CAPACITOR ASSEMBLY

(75) Inventors: Bum-Joon KIM, Seoul (KR); Dae-Kyun OH, Jincheon-gun (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/857,051

(22) Filed: Sep. 18, 2007

(30) Foreign Application Priority Data
Jan. 12, 2007 (KR) 10-2007-0003558

(51) Int. Cl. H01G 4/00; H01G 9/00; G09G 3/34

(52) U.S. Cl. 361/301.3; 29/25.03; 345/84

(57) ABSTRACT

A capacitor assembly includes a first electrode, a second electrode, a dielectric portion, a body and a conductive cover. The second electrode overlaps the first electrode. The dielectric portion is interposed between the first and second electrodes. The body surrounds an outer surface of the dielectric portion, the first electrode and the second electrode, and partially exposes end portions of the first and second electrodes. The conductive cover covers a side surface of the body, and has a greater width than a width of each of the end portions of the first and second electrodes. Therefore, yield of the capacitor assembly is increased, and defects are decreased.

The present application claims priority to Korean Patent Application No. 2007-03558, filed on Jan. 12, 2007, and all the benefits accruing therefrom under 35 U.S.C. § 119, the contents of which in its entirety are herein incorporated by reference.

### BACKGROUND OF THE INVENTION

1. Field of the Invention

The present invention relates to a capacitor assembly, a display device including the capacitor assembly, and a method thereof. More particularly, the present invention relates to a capacitor assembly capable of improving impact resistance, a display device including the capacitor assembly to decrease defects, and a method of manufacturing the capacitor assembly.

2. Description of the Related Art

Electronic devices such as a display device, an information processing device, etc., have been widely used in various fields. As the electronic devices have been developed, an integration degree of electric elements in the electronic devices is increased. The electric elements include a capacitor, a resistor, an integrated circuit, etc. In addition, when size and thickness of the electric devices are decreased, the integration degree of the electric elements is increased.

However, as the integration degree of the electric elements increases, the electric devices become vulnerable to a physical impact. For example, portable electric devices such as a cellular phone, a notebook computer, a personal digital assistant (“PDA”), etc., are exposed to the physical impact, thereby increasing defects.

### BRIEF SUMMARY OF THE INVENTION

The present invention provides a capacitor assembly capable of improving impact resistance.

The present invention also provides a display device having the above-mentioned capacitor assembly to decrease defects.

The present invention also provides a method of manufacturing the capacitor assembly.

Exemplary embodiments of a capacitor assembly in accordance with the present invention include a first electrode, a second electrode, a dielectric portion, a body and a conductive cover. The second electrode overlaps the first electrode. The dielectric portion is interposed between the first and second electrodes. The body surrounds an outer surface of the dielectric portion, the first electrode and the second electrode, and partially exposes end portions of the first and second electrodes. The conductive cover covers a side surface of the body, and has a greater width than a width of each end portion of the first and second electrodes.

Other exemplary embodiments of a capacitor assembly in accordance with the present invention include a first electrode, a second electrode, a dielectric portion and a body. The second electrode overlaps the first electrode. The dielectric portion is interposed between the first and second electrodes. The body surrounds an outer surface of the dielectric portion, the first electrode and the second electrode to partially expose end portions of the first and second electrodes. A lower width of the body is smaller than a central width of the body.

Exemplary embodiments of a display device in accordance with the present invention include a display panel, a base substrate and a driving circuit part. The display panel displays an image. The base substrate is electrically connected to the display panel. The driving circuit part includes a capacitor assembly and a driving element to apply a plurality of driving signals to the display panel. The driving element is electrically connected to the capacitor assembly. The capacitor assembly includes a first electrode, a second electrode, a dielectric portion, a body and a conductive cover. The first electrode is on the base substrate. The second electrode overlaps the first electrode on the base substrate. The dielectric portion is interposed between the first and second electrodes. The body surrounds an outer surface of the dielectric portion, the first electrode and the second electrode, and partially exposes end portions of the first and second electrodes. The conductive cover covers a side surface of the body, and has a greater width than a width of each of the end portions of the first and second electrodes.

Exemplary embodiments of a method of manufacturing a capacitor assembly in accordance with the present invention include overlapping a first electrode and a second electrode, interposing a dielectric portion between the first and second electrodes, surrounding an outer surface of the dielectric portion, the first electrode and the second electrode with a body, partially exposing end portions of the first and second electrodes through openings in the body, and covering a side surface of the body with a conductive cover, the conductive cover having a greater width than a width of each of the end portions of the first and second electrodes.

According to the capacitor assembly and the display device having the capacitor assembly of the present invention, a tensile strength of the capacitor assembly is increased so that the capacitor assembly is protected from an externally provided impact. In addition, the stress applied to an edge or a corner of the body is dispersed. Thus, a yield of the display device is increased.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is a perspective view illustrating a first exemplary embodiment of a driving circuit part in accordance with the present invention;

FIG. 2 is a perspective view illustrating an exemplary capacitor assembly shown in FIG. 1;

FIG. 3 is a cross-sectional view taken along line I-I′ shown in FIG. 2;

FIG. 4 is a perspective view illustrating a second exemplary embodiment of a capacitor assembly in accordance with the present invention;

FIG. 5 is a perspective view illustrating a third exemplary embodiment of a capacitor assembly in accordance with the present invention;

FIG. 6 is a perspective view illustrating a fourth exemplary embodiment of a capacitor assembly in accordance with the present invention;

FIG. 7 is a cross-sectional view taken along line II-II′ shown in FIG. 6;

FIG. 8 is a perspective view illustrating a fifth exemplary embodiment of a capacitor assembly in accordance with the present invention;

FIG. 9 is a cross-sectional view taken along line III-III′ shown in FIG. 8;

FIG. 10 is a perspective view illustrating a sixth exemplary embodiment of a capacitor assembly in accordance with the present invention;

FIG. 11 is a perspective view illustrating a seventh exemplary embodiment of a capacitor assembly in accordance with the present invention;

FIG. 12 is a perspective view illustrating an eighth exemplary embodiment of a capacitor assembly in accordance with the present invention;

FIG. 13 is a perspective view illustrating a ninth exemplary embodiment of a capacitor assembly in accordance with the present invention;

FIG. 14 is a cross-sectional view taken along line IV-IV′ shown in FIG. 13;

FIG. 15 is a cross-sectional view illustrating a tenth exemplary embodiment of a capacitor assembly in accordance with the present invention;

FIG. 16 is a perspective view illustrating an eleventh exemplary embodiment of a capacitor assembly in accordance with the present invention; and

FIG. 17 is a perspective view illustrating an exemplary embodiment of a display device in accordance with the present invention.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

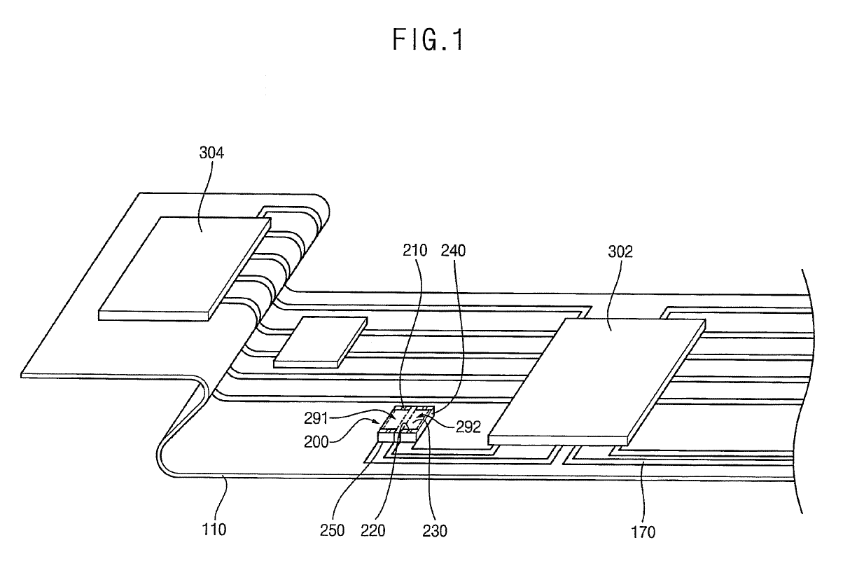

FIG. 1 is a perspective view illustrating a first exemplary embodiment of a driving circuit part in accordance with the present invention.

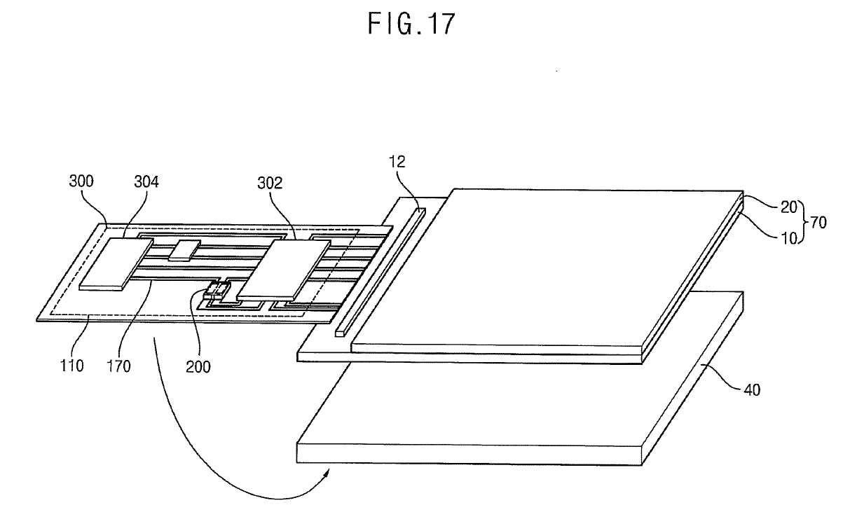

Referring to FIG. 1, the driving circuit part is formed on a base substrate 110. The driving circuit part generates a plurality of driving signals to a display panel (as will be described below with respect to FIG. 17). The driving circuit part includes a plurality of driving elements 302 and 304 and a capacitor assembly 200. The driving circuit part may further include a transmission line 170.

The base substrate 110 includes an insulating material. In one exemplary embodiment, the base substrate 110 includes a synthetic resin, and the base substrate 110 is a flexible substrate that may be bent by an external force. Alternatively, the base substrate 110 may include glass, ceramic, etc.

The driving elements 302 and 304 are mounted on the base substrate 110, and are electrically connected to the capacitor assembly 200 and the transmission line 170.

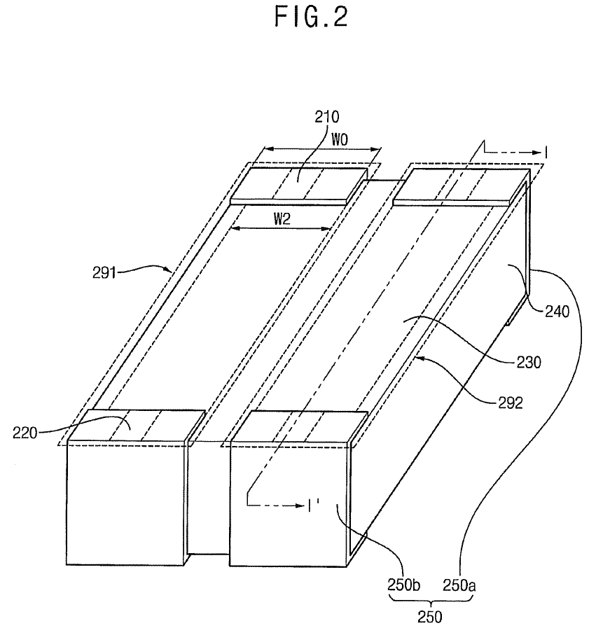

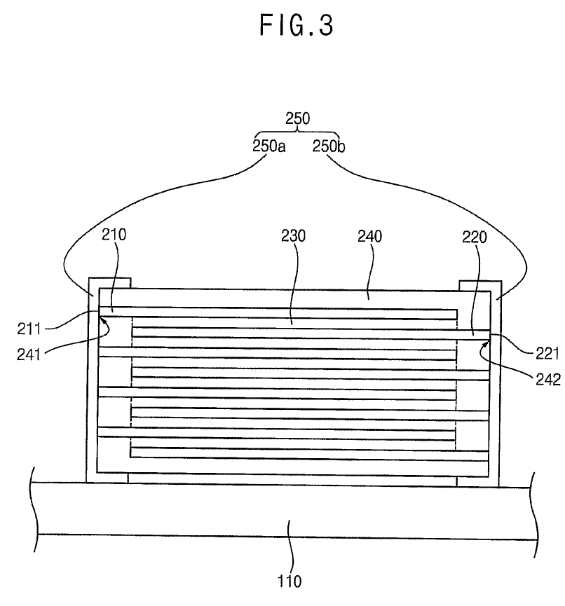

FIG. 2 is a perspective view illustrating an exemplary capacitor assembly shown in FIG. 1. FIG. 3 is a cross-sectional view taken along line I-I′ shown in FIG. 2.

Referring to FIGS. 1 to 3, the capacitor assembly 200 includes a plurality of first electrodes 210, a plurality of second electrodes 220, a plurality of dielectric portions 230, a body 240 and a plurality of conductive covers 250 to form a plurality of capacitors 291 and 292. In FIGS. 1 to 3, the capacitor assembly 200 includes two capacitors 291 and 292. Alternatively, the capacitor assembly 200 may include any number of capacitors, for example the number of the capacitors may be no less than three.

The first electrodes 210 are spaced apart from each other on the base substrate 110. In one exemplary embodiment, the first electrodes 210 have substantially plate shape, and the first electrodes 210 of each of the capacitors 291 and 292 are overlapped with each other. An end portion 211 of the first electrode 210 may have a width that is smaller than a width W2 of a main portion of the first electrode 210. The end portions 211 may be adjacent a first end of the capacitors 291 and 292.

The first electrodes 210 may include a conductive material such as nickel (Ni), copper (Cu), lead (Pb), lead-silver alloy, etc.

The second electrodes 220 are spaced apart from each other on the base substrate 110, and are overlapped with the first electrodes 210. In one exemplary embodiment, the second electrodes 220 have substantially a plate shape, and the second electrodes 220 of each of the capacitors 291 and 292 overlap each other. Although not restricted thereto, the second electrodes 220 may include substantially the same conductive material as the first electrodes 210. An end portion 221 of the second electrode 220 may have a width that is smaller than a width W2 of a main portion of the second electrode 220. The end portions 221 may be adjacent a second end of the capacitors 291 and 292, where the second end is opposite the first end.

The dielectric portions 230 are interposed between the layers of first and second electrodes 210 and 220 to form the capacitors 291 and 292. The dielectric portions 230 may include a ceramic material such as barium titanate, barium strontium titanate, manganese oxide, glass frit, magnesium zinc titanate, etc. In FIGS. 1 to 3, the dielectric portions 230 include barium titanate. Alternatively, the dielectric portions 230 may include a synthetic resin such as polystyrene, polypropylene, etc.

In one exemplary embodiment, the first and second electrodes 210 and 220 of each of the capacitors 291 and 292 are alternately arranged to interpose the dielectric portions 230.

The body 240 surrounds an outer surface of the dielectric portions 230, the first electrodes 210 and the second electrodes 220 to protect the dielectric portions 230, the first electrodes 210 and the second electrodes 220. In addition, end portions 211 of the first electrodes 210 and end portions 221 of the second electrodes 220 are exposed through openings 241 and 242 formed on opposite side surfaces of the body 240. In FIGS. 1 to 3, the body 240 is integrally formed with the dielectric portions 230, and includes substantially the same material as the dielectric portions 230. The body 240 may include a polygonal prism shape, a circular column shape, an elliptical column shape, etc. In one exemplary embodiment as illustrated in FIG. 2, the body 240 may include a rectangular parallelepiped shape.

The conductive covers 250 are disposed on the opposite side surfaces of the body 240, adjacent first and second ends of the capacitors 291 and 292 to cover the exposed portions of the end portions 211 and 221 of the first and second electrodes 210 and 220 and the opposite side surfaces of the body 240 adjacent to the end portions 211 and 221. Each of the conductive covers 250 is electrically connected to the first electrodes 210 of each of the capacitors 291 and 292 or the second electrodes 220 of each of the capacitors 291 and 292. A plurality of the conductive covers 250 may be disposed on each of the opposite side surfaces of the body 240. In FIGS. 1 to 3, two conductive covers 250 are disposed on each of the opposite side surfaces of the body 240, one for each capacitor 291 and 292. In one exemplary embodiment, the conductive covers 250 may include a first conductive cover 250a electrically connected to the first electrodes 210 of each of the capacitors 291 and 292, and a second conductive cover 250b electrically connected to the second electrodes 220 of each of the capacitors 291 and 292. The first and second conductive covers 250a and 250b may not have polarity.

When the base substrate 110 is bent by an externally provided pressure in a horizontal direction of the capacitor assembly 200, the capacitor assembly 200 may be bent in a longitudinal direction of the capacitor assembly 200. When the capacitor assembly 200 is bent in the longitudinal direction of the capacitor assembly, a stress is concentrated on a lower portion of the capacitor assembly 200 so that a tensile stress is concentrated on an edge of the body 240.

In FIGS. 1 to 3, a width WO of each of the conductive covers 250 may be equal to or greater than a width W2 of the main portions of each of the first and second electrodes 210 and 220. Thus, the conductive covers 250 widely cover the side surfaces of the body 240 to dissipate the tensile stress that is applied to the body 240. In one exemplary embodiment, the conductive covers 250 may be extended toward the corners of the body 240.

When the base substrate 110 is bent by the externally provided pressure in the longitudinal direction of the capacitor assembly 200, the capacitor assembly 200 may be bent in the horizontal direction of the capacitor assembly 200. When the capacitor assembly 200 is bent in the horizontal direction of the capacitor assembly 200, the first and second electrodes 210 and 220 absorb the tensile stress to protect the body 240.

The conductive covers 250 include a conductive material such as metal, metal alloy, etc. The conductive covers 250 include a conductive material such as silver (Ag), silver-palladium alloy, aluminum (Al), tantalum (Ta), etc.

The conductive covers 250 are attached to the base substrate 110 to be electrically connected to the transmission line 170. In FIGS. 1 to 3, the conductive covers 250 may be attached to the base substrate 110 through a soldering (not shown). Alternatively, the conductive covers 250 may be combined with the base substrate 110 through a socket (not shown).

According to the driving circuit part and the capacitor assembly 200 of FIGS. 1 to 3, the conductive covers 250 have greater widths than the first and second electrodes 210 and 220 to increase the tensile strength of the side surface of the capacitor assembly 200, thereby protecting the capacitor assembly 200 from an externally provided impact. Thus, defects of the capacitor assembly 200 are decreased.

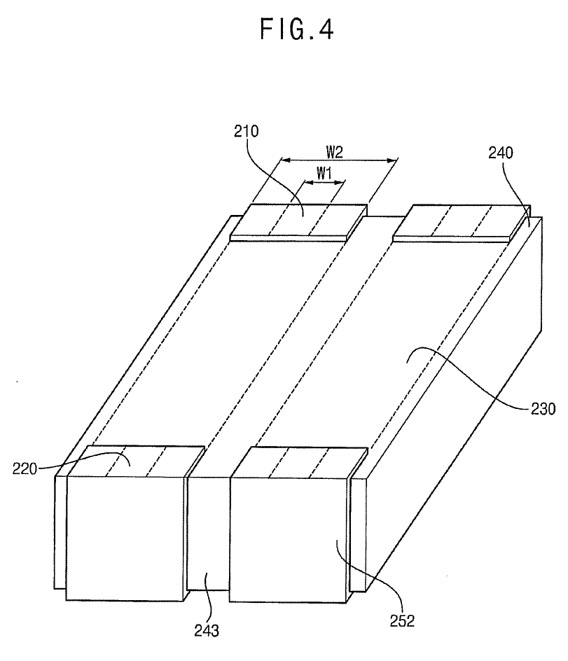

FIG. 4 is a perspective view illustrating a second exemplary embodiment of a capacitor assembly in accordance with the present invention. The capacitor assembly of the second exemplary embodiment is substantially the same as the first exemplary embodiment shown in FIGS. 1 to 3 except for a conductive cover 252. Thus, the same reference numerals will be used to refer to the same or like parts as those described in FIGS. 1 to 3 and any further explanation concerning the above elements will be omitted.

Referring to FIG. 4, the conductive covers 252 are disposed on opposite side surfaces 243 of the body 240 to cover end portions 211 and 221 (shown in FIG. 3) of first and second electrodes 210 and 220, which are exposed through openings 241 and 242 (shown in FIG. 3) formed on the opposite side surfaces 243 of the body 240, and the opposite side surfaces adjacent to the openings 241 and 242.

A width of each of the conductive covers 252 is greater than a width W1 of the end portions 211 and 221 of the first and second electrodes 210 and 220. The width of each of the conductive covers 252 may be smaller than a width W2 of each of the main portions of the first and second electrodes 210 and 220, and may be greater than the width W1 of each of the end portions of the first and second electrodes 210 and 220. In FIG. 4, the first and second electrodes 210 and 220 may have substantially the same width W2, and each of the conductive covers 252 may be spaced apart from corners of the body 240 by a constant distance.

According to the capacitor assembly of FIG. 4, the conductive covers 252 have substantially the same width W2 as the main portions of the first and second electrodes 210 and 220. Thus, fabrication process of the capacitor assembly is improved, even if the conductive covers 252 are misaligned from the body 240.

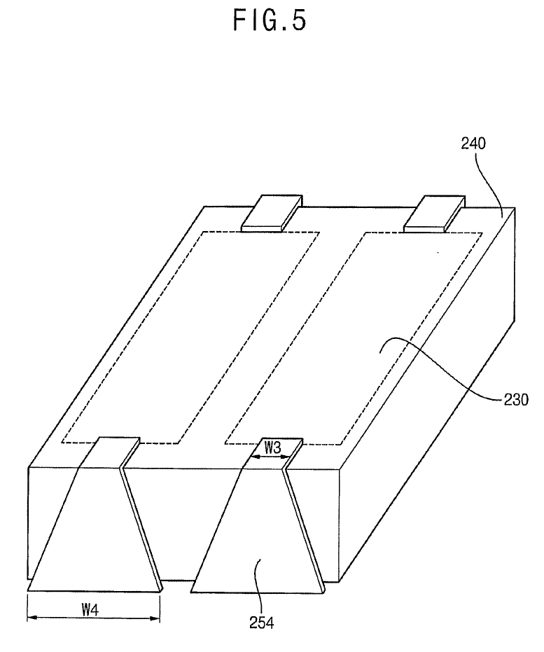

FIG. 5 is a perspective view illustrating a third exemplary embodiment of a capacitor assembly in accordance with the present invention. The capacitor assembly of the third exemplary embodiment is substantially the same as in FIGS. 1 to 3 except for a conductive cover 254. Thus, the same reference numerals will be used to refer to the same or like parts as those described in FIGS. 1 to 3 and any further explanation concerning the above elements will be omitted.

Referring to FIG. 5, the conductive covers 254 are disposed on opposite side surfaces of the body 240.

A lower width W4 of each of the conductive covers 254 is greater than an upper width W3 of each of the conductive covers 254. A base substrate 110 (shown in FIG. 1) is a flexible substrate, and a lower portion of the capacitor assembly shown in FIG. 5 is attached to the base substrate 110.

When the capacitor assembly is bent in a longitudinal direction of the capacitor assembly, a stress is concentrated on a lower portion of the capacitor assembly so that a tensile stress is applied on the lower portion of the capacitor assembly.

According to the capacitor assembly of FIG. 5, the lower width W4 of each of the conductive covers 254 is greater than the upper width W3 so that the conductive covers 254 absorbs the tensile stress applied to the lower portion of the capacitor assembly. Therefore, yield of the capacitor assembly is increased.

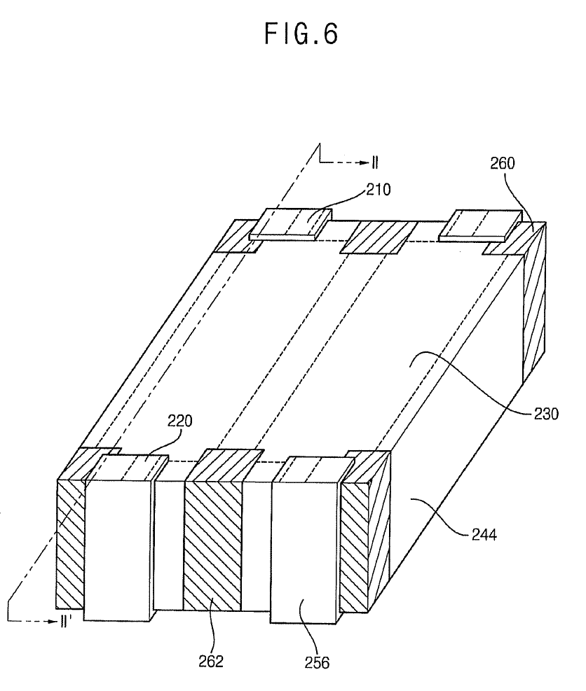

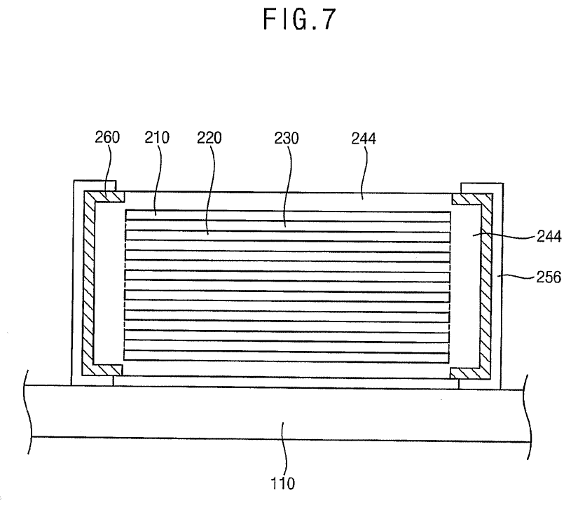

FIG. 6 is a perspective view illustrating a fourth exemplary embodiment of a capacitor assembly in accordance with the present invention. FIG. 7 is a cross-sectional view taken along line II-II′ shown in FIG. 6. The capacitor assembly of the fourth exemplary embodiment is substantially the same to the first exemplary embodiment shown in FIGS. 1 to 3 except for a conductive cover 256 and a reinforcing member 260. Thus, the same reference numerals will be used to refer to the same or like parts as those described in FIGS. 1 to 3 and any further explanation concerning the above elements will be omitted.

Referring to FIGS. 6 and 7, the capacitor assembly includes a plurality of first electrodes 210, a plurality of second electrodes 220, a plurality of dielectric portions 230, a body 244, a plurality of reinforcing members 260 and a plurality of conductive covers 256.

The body 244 covers the dielectric portions 230, the first electrodes 210 and the second electrodes 220. A plurality of openings is formed on opposite side surfaces of the body 244 to partially expose end portions of the first electrodes 210 and end portions of the second electrodes 220.

The reinforcing members 260 are disposed on corners of the body 244 to increase a tensile strength of the capacitor assembly. In FIGS. 6 and 7, the reinforcing members 260 are integrally formed with the body 244.

The reinforcing members 260 may include metal, alloy, metal oxide, etc. In one exemplary embodiment, the reinforcing members 260 include tungsten alloy.

In FIGS. 6 and 7, the capacitor assembly may further include an auxiliary reinforcing member 262 on a center of each of the opposite side surfaces of the body 244. Although not limited thereto, the auxiliary reinforcing member 262 may include substantially the same material as the reinforcing member 260, and may be electrically insulated from the conductive covers 256.

The conductive covers 256 are disposed on the opposite side surfaces of the body 244 to cover the end portions of the first and second electrodes 210 and 220, which are exposed through the openings formed on the opposite side surfaces, and to cover portions of the opposite side surfaces adjacent to the exposed end portions of the first and second electrodes 210 and 220. In FIGS. 6 and 7, the conductive covers 256 may partially overlap with the reinforcing members 260.

The conductive covers 256 are spaced apart from the auxiliary reinforcing members 262. If one of the auxiliary reinforcing members 262 interposed between the conductive covers 256 is overlapped with the conductive covers 256, then the capacitor assembly may have a short circuit. Therefore, the conductive covers 256 are spaced apart from the auxiliary reinforcing member 262, and are electrically insulated from the auxiliary reinforcing member 262.

In FIGS. 6 and 7, a width of each of the conductive covers 256 is smaller than a width of a main portion of each of the first and second electrodes 210 and 220, and is greater than a width of each of the end portions of the first and second electrodes 210 and 220.

According to the capacitor assembly of FIGS. 6 and 7, the capacitor assembly includes the reinforcing members 260 so that the tensile strength of the corners of the capacitor assembly is increased. In addition, the capacitor assembly includes the auxiliary reinforcing members 262 to increase the tensile strength of the opposite side surfaces of the capacitor assembly. Thus, defects of the capacitor assembly are decreased.

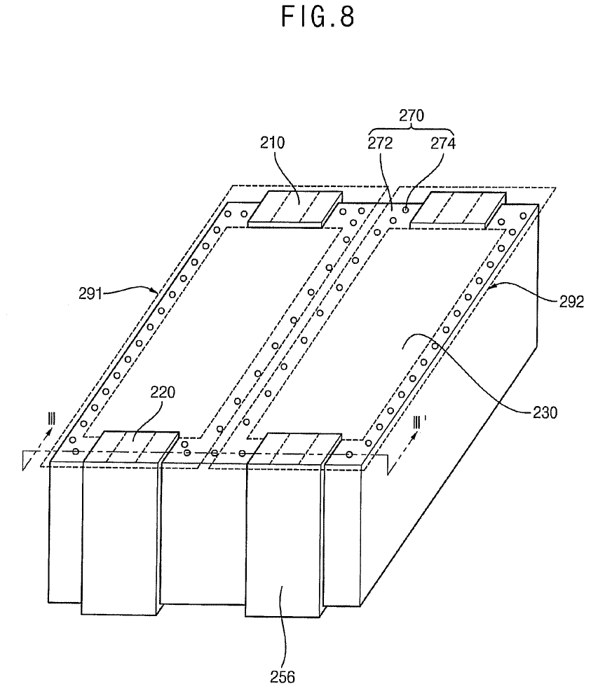

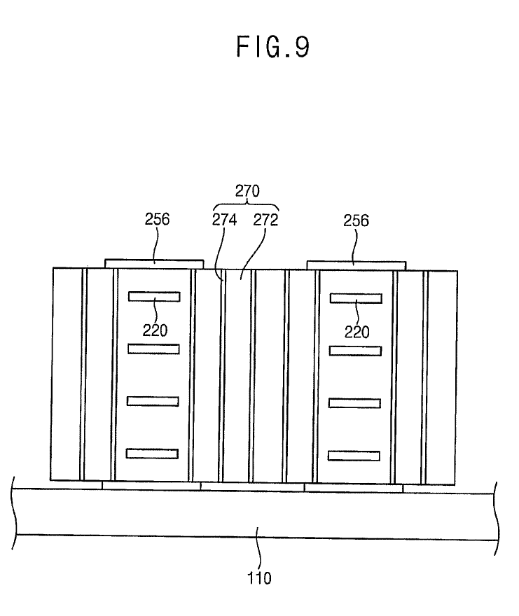

FIG. 8 is a perspective view illustrating a fifth exemplary embodiment of a capacitor assembly in accordance with the present invention. FIG. 9 is a cross-sectional view taken along line III-III′ shown in FIG. 8. The capacitor assembly of the fifth exemplary embodiment is substantially the same as the first exemplary embodiment shown in FIGS. 1 to 3, except for a conductive cover 256 and a body 270. Thus, the same reference numerals will be used to refer to the same or like parts as those described in FIGS. 1 to 3 and any further explanation concerning the above elements will be omitted.

Referring to FIGS. 8 and 9, the body 270 includes a ceramic frame 272 and a reinforcing fiber 274 disposed in the ceramic frame 272. The ceramic frame 272 may include a ceramic material such as barium titanate, barium strontium titanate, manganese oxide, glass frit, magnesium zinc titanate, etc. The reinforcing fiber 274 increases a tensile strength of the ceramic frame 272. The reinforcing fiber 274 may include a fiber such as a carbon fiber, a metal fiber, a ceramic fiber, an organic fiber, etc.

The reinforcing fiber 274 is aligned in a direction substantially perpendicular to the first and second electrodes 210 and 220 to increase a tensile strength of the body 270.

A width of each of the conductive covers 256 is smaller than a width of the main portion of each of the first and second electrodes 210 and 220, and is greater than a width of each of the end portions of the first and second electrodes 210 and 220.

In one exemplary embodiment, in order to form the body 270, a plurality of ceramic sheets, on which the first and second electrodes 210 and 220 are formed by a printing method, are stacked to form capacitors 291 and 292. The reinforcing fiber 274 may be aligned adjacent to the capacitors 291 and 292. A ceramic powder including an organic binder may then be filled in a region adjacent to the reinforcing fiber 274 and fired to form the body 270.

According to the capacitor assembly of FIGS. 8 and 9, the body 270 includes the reinforcing fiber 274 to increase the tensile strength of the body 270 in a vertical direction of the capacitor assembly.

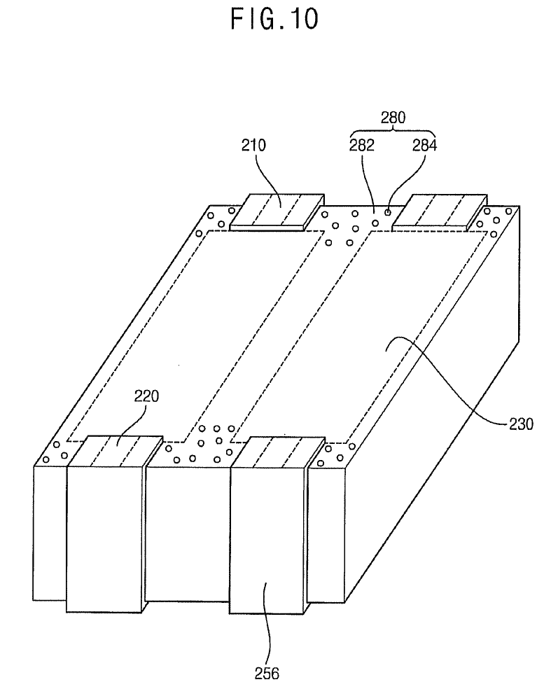

FIG. 10 is a perspective view illustrating a sixth exemplary embodiment of a capacitor assembly in accordance with the present invention. The capacitor assembly of the sixth exemplary embodiment is substantially the same as the embodiment shown in FIGS. 8 and 9 except for a location of a reinforcing fiber 284. Thus, the same reference numerals will be used to refer to the same or like parts as those described in FIGS. 8 and 9 and any further explanation concerning the above elements will be omitted.

Referring to FIG. 10, the body 280 includes a ceramic frame 282 and a reinforcing fiber 284 disposed in the ceramic frame 282. The reinforcing fiber 284 is adjacent to a corner of the capacitor assembly, and may further be adjacent to opposite sides of the body 280 to which the conductive covers 256 are applied.

The first and second electrodes 210 and 220 include a metal that has greater tensile strength than the ceramic frame 282. When the base substrate 110, on which the capacitor assembly is attached, is bent, a tensile strength applied to a central portion of the capacitor assembly is absorbed by the main portions of the first and second electrodes 210 and 220. In addition, a tensile strength applied to a peripheral region of the capacitor assembly is absorbed by the reinforcing fiber 284.

According to the capacitor assembly of FIG. 10, the reinforcing fiber 284 is disposed adjacent to a portion of the body 280, to which the tensile strength is applied, so that an amount of the reinforcing fiber 284 is decreased. Thus, a manufacturing cost of the capacitor assembly is decreased.

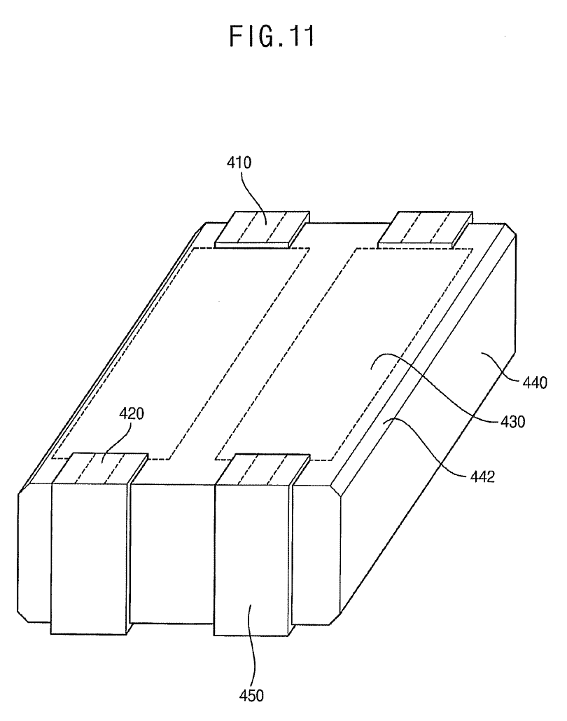

FIG. 11 is a perspective view illustrating a seventh exemplary embodiment of a capacitor assembly in accordance with the present invention. The capacitor assembly of the seventh exemplary embodiment is substantially the same as the first exemplary embodiment shown in FIGS. 1 to 3 except for a conductive cover 450 and a body 440. Thus, any further explanation concerning the same or like parts will be omitted.

Referring to FIG. 11, the body 440 covers a plurality of dielectric portions 430, a plurality of first electrodes 410, and a plurality of second electrodes 420. The body 440 includes a plurality of openings formed on opposite side surfaces of the body 440, through which end portions of the first electrodes 410 and end portions of the second electrodes 420 are exposed. In FIG. 11, the body 440 is integrally formed with the dielectric portions 430, and includes substantially the same material as the dielectric portions 430.

On longitudinal sides of the body 440, an upper edge and a lower edge of the body 440 may be chamfered to form an octagonal parallelepiped shape including inclined surfaces 442 on the upper and lower edges. In FIG. 11, the inclined surfaces 442 are not overlapped with the first and second electrodes 410 and 420 when viewed on a plane, such as in a top plan view, and each of the inclined surfaces 442 forms an angle of about 30 degrees to about 45 degrees with respect to a side surface of the body 440. Thus, the first and second electrodes 410 and 420 may have substantially the same shape as in prior embodiments. Alternatively, only the lower edge of the body 440 may be chamfered to form a hexagonal parallelepiped shape.

The inclined surfaces 442 dissipate the tensile stress applied to the edges of the body 440 to prevent formation of a crack in the body 440.

The conductive covers 450 are disposed on opposite side surfaces of the body 440 to cover the end portions of the first and second electrodes 410 and 420, which are exposed through the openings formed on the opposite side surfaces of the body 440 and to cover a portion of the opposite side surfaces adjacent to the end portions of the first and second electrodes 410 and 420.

A width of each of the conductive covers 450 may be smaller than a width of main portions of each of the first and second electrodes 410 and 420, and greater than a width of each of the end portions of the first and second electrodes 410 and 420.

According to the capacitor assembly of FIG. 11, the edges of the body 440 are chamfered to prevent the formation of a crack in the body 440. Thus, defects of the capacitor assembly are decreased.

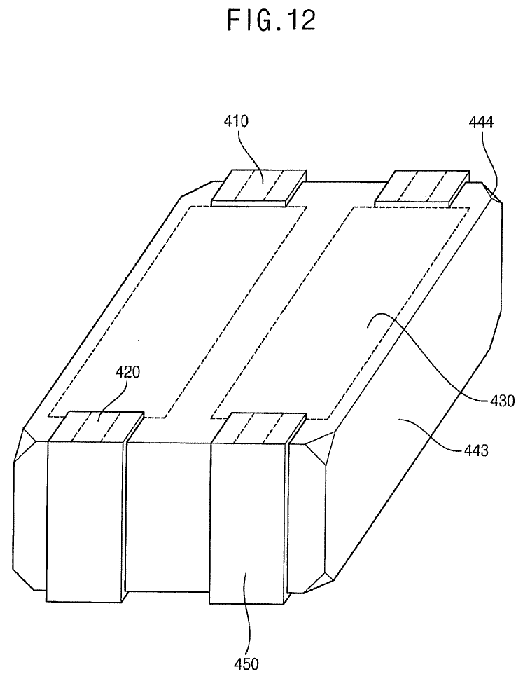

FIG. 12 is a perspective view illustrating an eighth exemplary embodiment of a capacitor assembly in accordance with the present invention. The capacitor assembly of the eighth exemplary embodiment is substantially the same as the seventh exemplary embodiment shown in FIG. 11 except for a body 443. Thus, the same reference numerals will be used to refer to the same or like parts as those described in FIG. 11 and any further explanation concerning the above elements will be omitted.

Referring to FIG. 12, upper and lower corners 444 of the body 443 are chamfered so that the body 443 has a rectangular parallelepiped shape having the chamfered upper and lower corners 444. Alternatively, only the lower corners 444 of the body 443 may be chamfered.

Therefore, a stress applied to the chamfered corners 444 of the body 443 is dissipated, thereby preventing a crack in the body 443.

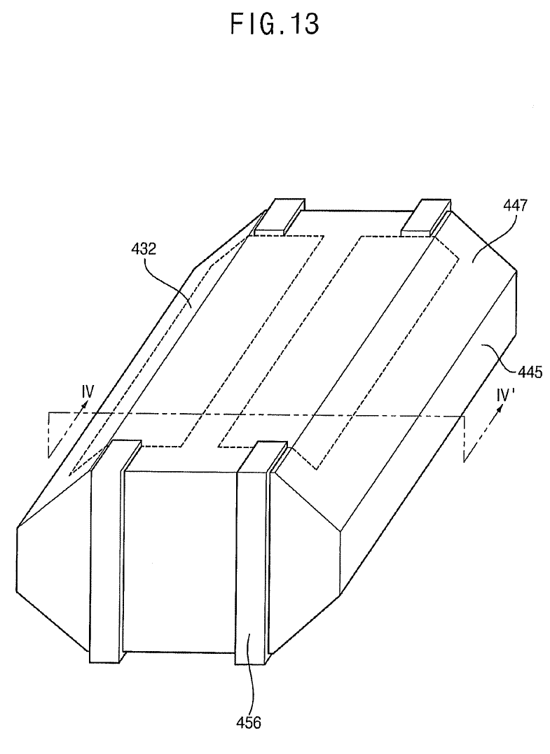

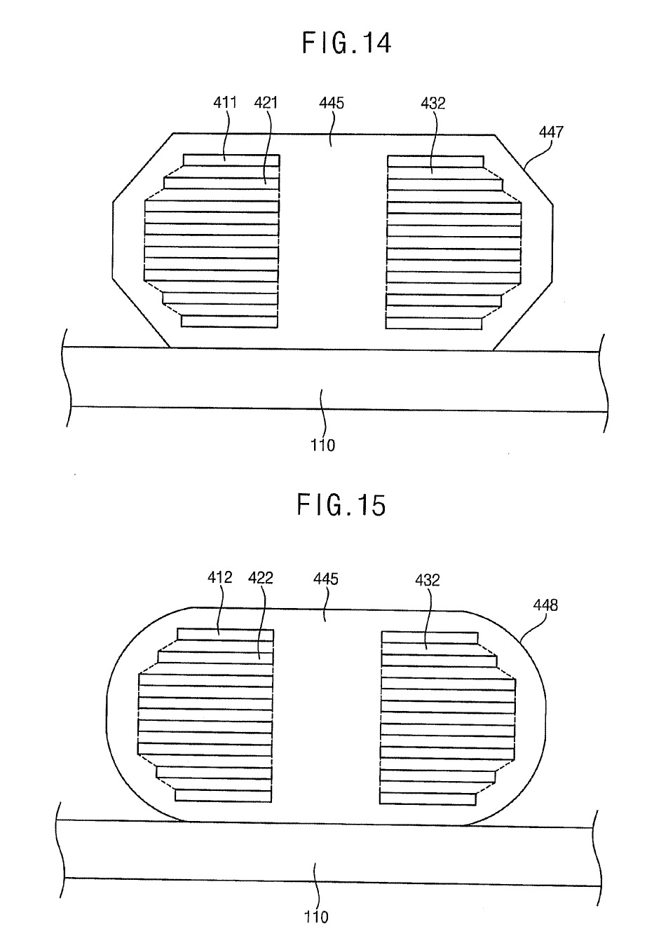

FIG. 13 is a perspective view illustrating a ninth exemplary embodiment of a capacitor assembly in accordance with the present invention. FIG. 14 is a cross-sectional view taken along line IV-IV′ shown in FIG. 13. The capacitor assembly of the ninth exemplary embodiment is substantially the same as the seventh exemplary embodiment shown in FIG. 11 except for a body 445, a first electrode 411, a second electrode 421, a dielectric portion 432 and a conductive cover 456. Thus, the same reference numerals will be used to refer to the same or like parts as those described in FIG. 11 and any further explanation concerning the above elements will be omitted.

Referring to FIGS. 13 and 14, longitudinal edges of the body 445 are chamfered so that the body 445 has an octagonal parallelepiped shape including a plurality of inclined surfaces 447. The inclined surfaces 447 are partially overlapped with the first and second electrodes 411 and 421 when viewed on a plane.

The first and second electrodes 411 and 421 on a central portion of the body 445 have a greater size than the first and second electrodes 411 and 421 on an upper portion and a lower portion of the body 445.

The dielectric portions 432 on the central portion of the body 445 are protruded relative to the dielectric portions 432 on the upper and lower portions of the body 445.

The conductive covers 456 are on opposite side surfaces of the body 445, and cover end portions of the first and second electrodes 411 and 421, which are exposed through openings formed on the opposite side surfaces of the body 445, and cover a portion of the opposite side surfaces adjacent to the openings.

In FIGS. 13 and 14, each of the conductive covers 456 has substantially the same width as end portions of each of the first and second electrodes 411 and 421.

According to the capacitor assembly of FIGS. 13 and 14, size of the inclined surfaces 447 of the body 445 is increased so that the stress applied to the edges of the body 445 is effectively dissipated.

FIG. 15 is a cross-sectional view illustrating a tenth exemplary embodiment of a capacitor assembly in accordance with the present invention. The capacitor assembly of the tenth exemplary embodiment is substantially the same as the ninth exemplary embodiment shown in FIGS. 13 and 14 except for shape of a body 445. Thus, the same reference numerals will be used to refer to the same or like parts as those described in FIGS. 13 and 14 and any further explanation concerning the above elements will be omitted.

Referring to FIG. 15, edges of the body 445 are rounded so that the body 445 has a plurality of curved surfaces 448. The curved surfaces 448 are partially overlapped with the first and second electrodes 412 and 422 when viewed on a plane, such as in a top plan view. Therefore, an impact resistance of the capacitor assembly is increased so that defects of the capacitor assembly are decreased.

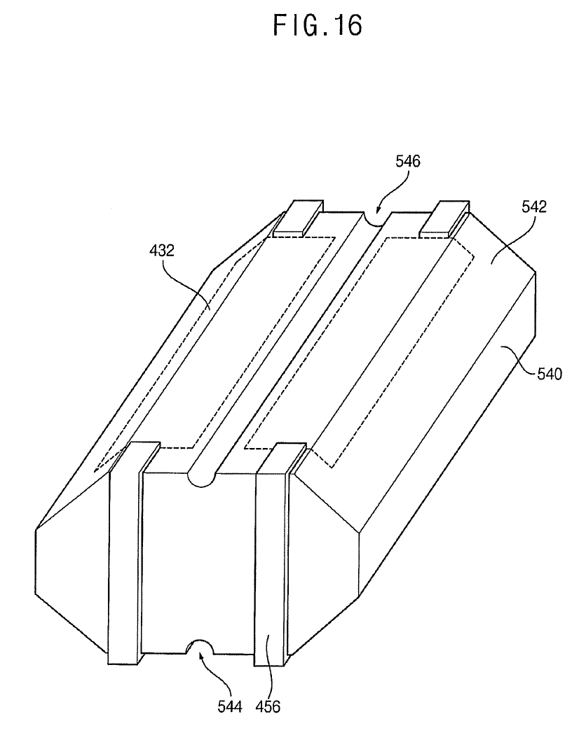

FIG. 16 is a perspective view illustrating an eleventh exemplary embodiment of a capacitor assembly in accordance with the present invention. The capacitor assembly of the eleventh exemplary embodiment is substantially the same as the ninth exemplary embodiment shown in FIGS. 13 and 14 except for a body 540. Thus, the same reference numerals will be used to refer to the same or like parts as those described in FIGS. 13 and 14 and any further explanation concerning the above elements will be omitted.

Referring to FIG. 16, the body 540 includes a plurality of inclined surfaces 542 and a plurality of grooves 544, 546. Edges of the body 540 are chamfered to form the inclined surfaces 542. The grooves 544, 546 are interposed between opposite edges of the body 540 such that they extend parallel to each other between adjacent capacitors. The groove 546 may extend on a top surface of the body 540, and the groove 544 may extend on a bottom surface of the body 540.

The grooves 544 and 546 are extended in a longitudinal direction of the capacitor assembly to dissipate a stress applied between the opposite edges.

Therefore, formation of a crack on a central portion of the body 540 is prevented so that defects of the capacitor assembly are decreased.

FIG. 17 is a perspective view illustrating an exemplary embodiment of a display device in accordance with the present invention.

Referring to FIG. 17, the display device includes a display panel 70, a flexible base substrate 110, an integrated driving circuit part 300, and a backlight assembly 40.

The display panel 70 includes an array substrate 10, an opposite substrate 20, a panel driving part 12 and a liquid crystal layer (not shown), and displays an image using light generated from the backlight assembly 40.

The array substrate 10 includes a plurality of thin film transistors (“TFTs”) (not shown) arranged in a matrix shape and a plurality of pixel electrodes (not shown) electrically connected to the TFTs, respectively.

The opposite substrate 20 faces the array substrate 10, and the liquid crystal layer is interposed between the array substrate 10 and the opposite substrate 20.

The panel driving part 12 is disposed on an end portion of the array substrate 10. The panel driving part 12 applies data and gate voltages to the TFTs based on driving signals generated from the integrated driving circuit part 300.

In FIG. 17, the display panel 70 includes a liquid crystal display (“LCD”) panel. Alternatively, the display panel may include an organic light emitting display (“OLED”) device, an electrophoresis display device, a plasma display panel (“PDP”) device, etc.

An end portion of the flexible base substrate 110 is connected to an end portion of the array substrate 10. In FIG. 17, the flexible base substrate 110 is electrically connected to the array substrate 10 through an anisotropic conductive film (“ACF”) (not shown).

The integrated driving circuit part 300 is on the flexible base substrate 110. The integrated driving circuit part 300 applies the driving signals to the panel driving part 12 based on an externally provided input signal.

The integrated driving circuit part 300 includes a transmission line 170, a plurality of driving elements 302 and 304 and a capacitor assembly 200.

In FIG. 17, the capacitor assembly 200 is electrically connected to the driving elements 302 and 304 through the transmission line 170 to stabilize a signal voltage that is transmitted through the transmission line 170.

The capacitor assembly 200 of the present invention is substantially the same as any one of the capacitor assemblies described with respect to FIGS. 1 to 16. Thus, any further explanation concerning the above elements will be omitted.

The backlight assembly 40 is disposed under the display panel 70 to supply the display panel 70 with light.

The flexible base substrate 110 is bent to be disposed on a rear surface of the backlight assembly 40.

When the flexible base substrate 110 is bent, a tensile stress is applied to the capacitor assembly 200 attached to the flexible base substrate 110. A conductive cover 250 (shown in FIG. 2) of the capacitor assembly 200 may widely cover the body 240 (shown in FIG. 2) of the capacitor assembly 200 to absorb the tensile stress.

According to the display device of FIG. 17, a mechanical strength of the capacitor assembly 200 is increased so that defects of the display device are decreased.

According to the present invention, the conductive covers may have greater widths than the exposed end portions of the first and second electrodes so that the tensile strength of the side surfaces of the capacitor assembly increases. Also, the conductive covers protect the capacitor assembly from an externally provided impact.

In addition, the capacitor assembly may include the reinforcing member so that the tensile strength of the side surfaces of the capacitor assembly is increased.

Furthermore, the body may include the reinforcing fiber so that the tensile strength in the vertical direction of the body is increased.

Also, the edges or the corners of the body may be chamfered to dissipate the stress applied to the edges of the corners of the body, thereby decreasing the defects of the capacitor assembly. In addition, the grooves may be formed between the opposite edges of the body to prevent the crack in the body.

While particular exemplary embodiments of the capacitor assembly have been described, it should be understood that alternative embodiments including combinations of any of the above-described exemplary embodiments would also be within the scope of this invention.

The present invention also sets forth a method of manufacturing a capacitor assembly in correlation with the exemplary embodiments described above with respect to FIGS. 1-16. The method of manufacturing may include overlapping a first electrode and a second electrode, interposing a dielectric portion between the first and second electrodes, surrounding an outer surface of the dielectric portion, the first electrode and the second electrode with a body, partially exposing end portions of the first and second electrodes through openings in the body, and covering a side surface of the body with a conductive cover, the conductive cover having a greater width than a width of each of the end portions of the first and second electrodes.

This invention has been described with reference to exemplary embodiments. It is evident, however, that many alternative modifications and variations will be apparent to those having skill in the art in light of the foregoing description. Accordingly, the present invention embraces all such alternative modifications and variations as fall within the spirit and scope of the appended claims.

What is claimed is:

1. A capacitor assembly comprising:
a first electrode;
a second electrode overlapping the first electrode;
a dielectric portion interposed between the first and second electrodes;
a body surrounding an outer surface of the dielectric portion, the first electrode and the second electrode, and partially exposing end portions of the first and second electrodes; and
a conductive cover that covers a side surface of the body, and having a greater width than a width of each of the end portions of the first and second electrodes.

2. The capacitor assembly of claim 1, wherein the conductive cover comprises:
a first conductive cover electrically connected to the first electrode; and
a second conductive cover electrically connected to the second electrode.

3. The capacitor assembly of claim 1, further comprising a reinforcing member disposed on a side edge of the body to increase a tensile strength of the capacitor assembly, wherein the reinforcing member comprises at least one of a metal, an alloy, and a metal oxide.

4. The capacitor assembly of claim 1, wherein the body comprises:
a ceramic frame; and
a reinforcing fiber disposed in the ceramic frame,
and wherein the reinforcing fiber is adjacent to a corner of the body.

5. The capacitor assembly of claim 4, wherein the reinforcing fiber extends in a direction substantially perpendicular to the first and second electrodes.

6. The capacitor assembly of claim 1, further comprising a plurality of first electrodes, a plurality of second electrodes and a plurality of dielectric portions, and
wherein the first and second electrodes and the dielectric portions define a plurality of capacitors, the capacitors spaced apart from each other in the body, and
wherein a lower width of the conductive cover is greater than an upper width of the conductive cover.

7. A capacitor assembly comprising:
a first electrode;
a second electrode overlapping the first electrode;
a dielectric portion interposed between the first and second electrodes; and
a body surrounding an outer surface of the dielectric portion, the first electrode and the second electrode to partially expose end portions of the first and second electrodes, a lower width of the body smaller than a central width of the body.

8. The capacitor assembly of claim 7, wherein an edge of the body is chamfered, and the first and second electrodes have substantially the same size.

9. The capacitor assembly of claim 7, wherein an inclined surface formed by chamfering the edge of the body partially overlaps the first and second electrodes in a plan view of the capacitor assembly.

10. The capacitor assembly of claim 9, further comprising a plurality of first electrodes and a plurality of second electrodes, and
wherein a subset of the first and second electrodes within a central portion of the body has a greater size than a subset of the first and second electrodes within upper and lower portions of the body.

11. The capacitor assembly of claim 7, further comprising a conductive cover that covers the exposed end portions and covers a portion of the body adjacent to the exposed end portions.

12. The capacitor assembly of claim 7, further comprising a plurality of first electrodes and a plurality of second electrodes, and
wherein the first and second electrodes and the dielectric portions define a plurality of capacitors, the capacitors spaced apart from each other in the body.

13. A display device comprising:
a display panel displaying an image;
a base substrate electrically connected to the display panel, the base substrate including a flexible substrate;
a driving circuit part including a capacitor assembly and a driving element to apply a plurality of driving signals to the display panel, the driving element electrically connected to the capacitor assembly, the capacitor assembly including:
a first electrode on the base substrate;
a second electrode overlapping the first electrode on the base substrate;
a dielectric portion interposed between the first and second electrodes;
a body surrounding an outer surface of the dielectric portion, the first electrode and the second electrode, and partially exposing end portions of the first and second electrodes; and
a conductive cover that covers a side surface of the body, and having a greater width than a width of the end portions of the first and second electrodes; and
a backlight assembly disposed under the display panel to supply the display panel with light.

14. The display panel of claim 13, wherein the flexible substrate is bent so that the flexible substrate is disposed on a rear surface of the backlight assembly.

15. A method of manufacturing a capacitor assembly, the method comprising:
overlapping a first electrode and a second electrode;
interposing a dielectric portion between the first and second electrodes;
surrounding an outer surface of the dielectric portion, the first electrode and the second electrode with a body;
partially exposing end portions of the first and second electrodes through openings in the body; and
covering a side surface of the body with a conductive cover, the conductive cover having a greater width than a width of each of the end portions of the first and second electrodes.

16. The method of claim 15, wherein covering a side surface of the body with a conductive cover includes:
electrically connecting a first conductive cover to the first electrode; and
electrically connecting a second conductive cover to the second electrode.

17. The method of claim 15, further comprising, extending the conductive cover toward a corner of the body.

18. The method of claim 15, further comprising, disposing a reinforcing member on a side edge of the body to increase a tensile strength of the capacitor assembly.

19. The method of claim 15, further comprising chamfering an edge portion of the body.

20. The method of claim 15, wherein surrounding an outer surface of the dielectric portion, the first electrode and the second electrode with a body includes forming the body from a ceramic frame and disposing reinforcing fibers within the ceramic frame in a direction substantially perpendicular to the first and second electrodes.
